(19) United States
(12) Patent Application Publication
(10) Pub. No.: US 2012/0105598 A1
(43) Pub. Date: May 3, 2012

(54) THREE-DIMENSIONAL IMAGING DEVICE

(75) Inventors: Masao Hiramoto, Osaka (JP); Masayuki Misaki, Hyogo (JP); Teruyuki Takizawa, Osaka (JP); Masaaki Suzuki, Osaka (JP)

(73) Assignee: PANASONIC CORPORATION, Osaka (JP)

(21) Appl. No.: 13/382,179

(22) PCT Filed: Feb. 10, 2011
(86) PCT No.: PCT/JP2011/000761

§ 371 Date: Jan. 4, 2012

(30) Foreign Application Priority Data
May 11, 2010 (JP) 2010-109653

(51) Int. Cl. H04N 13/02

(52) U.S. Cl. 348/49; 348/E13.074

(57) ABSTRACT

An image capture device according to the present invention includes an imaging lens 3, a light-transmitting section 2 with two polarizers, and a solid-state image sensor 1 that has multiple pixels and their associated polarization filters. A first polarization filter 50a is arranged to face a first group of pixels W1 and a second polarization filter 50b is arranged to face a second group of pixels W2. The respective transmission axes of the polarizing areas P(1) and P(2) of the light-transmitting section 2 form an angle θ between themselves. Also, the transmission axis of the first polarization filter 50a defines an angle α with respect to that of the polarizing area P(1). And the transmission axis of the second polarization filter 50b defines an angle β with respect to that of the polarizing area P(2). With such an arrangement adopted, the image capture device of the present invention can obtain images with parallax efficiently.

### TECHNICAL FIELD

The present invention relates to a single-lens 3D image capturing technology for capturing multiple images with parallax by using one optical system and one image sensor.

### BACKGROUND ART

Recently, the performance and functionality of digital cameras and digital movie cameras that use some image sensor such as a CCD and a CMOS have been enhanced to an astonishing degree. In particular, the size of a pixel structure for use in an image sensor has been further reduced these days thanks to rapid development of semiconductor device processing technologies, thus getting an even greater number of pixels and drivers integrated together in an image sensor. As a result, the resolution of an image sensor has lately increased rapidly from one million pixels to ten million or more pixels in a matter of few years. On top of that, the quality of an image captured has also been improved significantly as well. As for display devices, on the other hand, LCD and plasma displays with a reduced depth now provide high-resolution and high-contrast images, thus realizing high performance without taking up too much space. And such video quality improvement trends are now spreading from 2D images to 3D images. In fact, 3D display devices that achieve high image quality although they require the viewer to wear a pair of polarization glasses have been developed just recently and put on the market one after another.

As for the 3D image capturing technology, a typical 3D image capture device with a simple arrangement uses an image capturing system with two cameras to capture a right-eye image and a left-eye image. According to the so-called “two-lens image capturing” technique, however, two cameras need to be used, thus increasing not only the overall size of the image capture device but also the manufacturing cost as well. To overcome such a problem, methods that use a single camera for the same purpose have been researched and developed. For example, Patent Document No. 1 discloses a scheme that uses two polarizers, of which the polarization directions intersect with each other at right angles, and a rotating polarization filter. FIG. 12 illustrates an arrangement for an image capturing system that adopts such a scheme.

The image capturing system shown in FIG. 12 includes a 0-degree-polarization polarizer 11, a 90-degree-polarization polarizer 12, a reflective mirror 13, a half mirror 14, a circular polarization filter 15, a driver 16 that rotates the circular polarization filter 15, an optical lens 3, and an image capture device 9 for capturing the image that has been produced by the optical lens. In this arrangement, the half mirror 14 transmits the light that has been transmitted through the polarizer 12 but reflects the light that has been transmitted through the polarizer 11 and then reflected from the reflective mirror 13.

With such an arrangement, the incoming light rays are transmitted through the two polarizers 11 and 12, which are arranged at two different positions, have their optical axes aligned with each other by the reflective mirror 13 and the half mirror 14, pass through the circular polarization filter 15 and the optical lens 3 and then enter the image capture device 9, where an image is captured. The image capturing principle of this scheme is that two images with parallax are captured by rotating the circular polarization filter 15 so that the light rays that have entered the two polarizers 11 and 12 are imaged at mutually different times.

According to such a scheme, however, images at mutually different positions are captured time-sequentially by rotating the circular polarization filter 15, and therefore, those images with parallax cannot be captured at the same time, which is a problem. In addition, the durability of such a system is also a question mark because the system uses mechanical driving. On top of that, since all of the incoming light is received by the polarizers and the polarization filter, the quantity of the light received eventually by the image capture device 9 decreases by as much as 50%, which is non-negligible, either.

To overcome these problems, Patent Document No. 2 discloses a scheme for capturing two images with parallax without using such mechanical driving. According to such a scheme, incoming light rays are received in two separate areas and then the light rays that have come from those areas are condensed onto a single image sensor to capture an image there, but no mechanical driving section is used. Hereinafter, its image capturing principle will be described with reference to FIG. 13, which illustrates an arrangement for an image capturing system that adopts such a scheme. The image capturing system shown in FIG. 13 includes two polarizers 11 and 12, of which the polarization directions intersect with each other at right angles, reflective mirrors 13, an optical lens 3, and an image sensor 1. The image sensor 1 has a number of pixels 10 and polarization filters 17 and 18, each of which is provided one to one for an associated one of the pixels 10. The polarization filters 17 and 18 have the same property as the polarizers 11 and 12, respectively. And those polarization filters 17 and 18 are arranged alternately over all of those pixels.

With such an arrangement, the incoming light rays are transmitted through the polarizers 11 and 12, reflected from the reflective mirrors 13, passed through the optical lens 3 and then imaged by the image sensor 1. The light rays that have come after having been transmitted through the polarizers 11 and 12 are passed through the polarization filters 17 and 18 and then photoelectrically converted by the pixels that face those polarization filters 17 and 18, respectively. If the images to be produced by those incoming light rays that have been transmitted through the polarizers and 12 are called a “right-eye image” and a “left-eye image”, respectively, then the right-eye image and the left-eye images are generated by a group of pixels that face the polarization filters 17 and a group of pixels that face the polarization filter 18, respectively, after having been transmitted through the polarization filters 17 and 18.

As can be seen, according to the scheme disclosed in Patent Document No. 2, two polarization filters with mutually different properties are arranged alternately over the pixels of the image sensor, instead of using the circular polarization filter disclosed in Patent Document No. 1. As a result, although the resolution decreases to a half compared to the method of Patent Document No. 1, a right-eye image and a left-eye image can still be obtained at the same time.

According to such a technique, although two images with parallax can be certainly obtained by using a single image sensor, the incoming light has its quantity decreased considerably when being transmitted through the polarizers and then the polarization filters, and therefore, the resultant image comes to have significantly decreased sensitivity.

As another approach to the problem that the resultant image has decreased sensitivity, Patent Document No. 3 discloses a technique for mechanically changing the modes of operation from the mode of capturing two images that have parallax into the mode of capturing a normal image, and vice versa. Hereinafter, its image capturing principle will be described with reference to FIG. 14, which illustrates an arrangement for an image capturing system that uses such a technique. The image capture device shown in FIG. 14 includes a light transmitting member 19 that has two polarized light transmitting portions 20 and 21 and that transmits the light that has come from an optical lens 3 only through those transmitting portions, a light receiving member optical filter tray 22 in which particular component transmitting filters 23 that split the light that has come from the polarized light transmitting portions 20 and 21 and color filters 24 are arranged as a set, and a filter driving section 25 that removes the light transmitting member 19 and the particular component transmitting filters 23 from the optical path and inserts the color filters 24 onto the optical path instead, and vice versa.

According to this technique, by running the filter driving section 25, the light transmitting member 19 and the particular component transmitting filters 23 are used to capture two images with parallax, while the color filters 24 are used to capture a normal image. However, the two images with parallax are shot in basically the same way as in Patent Document No. 2, and therefore, the resultant image comes to have a significantly decreased sensitivity. When a normal color image is shot, on the other hand, the light transmitting member 19 is removed from the optical path and the color filters 24 are insetted instead of the particular component transmitting filters 23. As a result, a color image can be generated without decreasing the sensitivity.

### CITATION LIST

### Patent Literature

Patent Document No. 1: Japanese Patent Application Laid-Open Publication No. 62-291292

Patent Document No. 2: Japanese Patent Application Laid-Open Publication No. 62-217790

Patent Document No. 3: Japanese Patent Application Laid-Open Publication No. 2001-016611

### SUMMARY OF INVENTION

### Technical Problem

According to these conventional techniques, a single-lens camera can capture two images with parallax by using polarizers (or a polarized light transmitting member) and polarization filters. In this case, each of those polarizers and polarization filters is made up of two different kinds of polarization elements, of which the transmission axes are defined by 0 and 90 degrees, respectively. An object of the present invention is to provide an image capturing technique for capturing multiple images with parallax by a different method from these conventional ones. In the following description, such images with parallax will be referred to herein as “multi-viewpoint images”.

### Solution to Problem

A 3D image capture device according to the present invention includes: a light transmitting section with at least two polarizers; a solid-state image sensor that receives the light that has been transmitted through the light transmitting section; and an imaging section that produces an image on an imaging area of the solid-state image sensor. The light transmitting section includes a first polarizer, and a second polarizer, of which the transmission axis defines an angle θ (where 0 degrees<θ≦90 degrees) with respect to the transmission axis of the first polarizer. The solid-state image sensor includes a number of pixel blocks, each of which includes first and second pixels, a first polarization filter that is arranged to face the first pixel of each pixel block and of which the transmission axis defines an angle α (where 0 degrees≦α<90 degrees) with respect to the transmission axis of the first polarizer, and a second polarization filter that is arranged to face the second pixel of each pixel block and of which the transmission axis defines an angle β (where 0 degrees≦β<90 degrees and β≠α) with respect to the transmission axis of the first polarizer. The first polarization filter is arranged so as to receive the light rays that have been transmitted through the first and second polarizers, and the second polarization filter is also arranged so as to receive the light rays that have been transmitted through the first and second polarizers.

In one preferred embodiment, the light transmitting section has a transparent area that transmits incoming light irrespective of its polarization direction. Each pixel block further has a third pixel that receives the light rays that have been transmitted through the first and second polarizers and the transparent area, respectively, and outputs a photoelectrically converted signal representing the quantity of the light received.

In a specific preferred embodiment, |θ−(α+β)|≦20 degrees is satisfied.

In a more specific preferred embodiment, |θ−(α+β)|≦10 degrees is satisfied.

In each of these specific preferred embodiments, 80 degrees≦θ≦90 degrees is satisfied.

In another preferred embodiment, a line that passes the respective centers of the first and second pixels and a line that passes the respective centers of the first and second polarizers intersect with each other at right angles.

In still another preferred embodiment, each pixel block further includes a fourth pixel. The solid-state image sensor includes a first color filter, which is arranged so as to face the third pixel of each pixel block and to transmit a light ray representing a first color component, and a second color filter, which is arranged so as to face the fourth pixel of each pixel block and to transmit a light ray representing a second color component.

In this particular preferred embodiment, in each pixel block, the first, second, third and fourth pixels are arranged in matrix, in which the first pixel is arranged at a row 1, column 1 position, the second pixel is arranged at a row 2, column 2 position, the third pixel is arranged at a row 1, column 2 position, and the fourth pixel is arranged at a row 2, column 1 position.

In another preferred embodiment, one of the first and second color filters transmits at least a light ray representing a red component, while the other color filter transmits at least a light ray representing a blue component.

In still another preferred embodiment, one of the first and second color filters transmits a light ray representing a yellow component, while the other color filter transmits a light ray representing a cyan component.

In yet another preferred embodiment, the 3D image capture device further includes an image processing section, which generates an image representing the difference between two images with parallax using photoelectrically converted signals supplied from the first and second pixels.

In this particular preferred embodiment, the image processing section reads the photoelectrically converted signals from the first and second pixels a number of times, thereby generating the image representing the difference, of which the signal level has been increased, based on those photoelectrically converted signals that have been read.

An image generating method according to the present invention is designed to be used in the 3D image capture device of the present invention and includes the steps of: getting a first photoelectrically converted signal from the first pixel; getting a second photoelectrically converted signal from the second pixel; and generating an image representing the difference between two images with parallax based on the first and second photoelectrically converted signals.

### Advantageous Effects of Invention

In the 3D image capture device of the present invention, its light incident area has at least two polarizing areas, its image sensor has at least two kinds of pixel groups, for each of which a polarization filter is provided, and the transmission axis directions are different from each other in not only those two polarizing areas but also the two polarization filters that are arranged to face those two kinds of pixel groups. Thus, the images produced by two light rays that have passed through the two polarizing areas can be captured by the two kinds of pixel groups, which is equivalent to getting two different pieces of incident light information with two sensors having mutually different properties. That is why the relation between two inputs and their associated outputs can be represented by a particular mathematical equation. Stated otherwise, the two inputs can be derived from the two outputs by making calculations. Consequently, by getting image information from the two polarizing areas and subjecting the image information to differential processing, a differential image can be obtained.

Also, if the light incident area further has a transparent area and if the device is designed so that the light that has been transmitted through the transparent area is incident on a third pixel group, a normal two-dimensional image, as well as the differential image, can be obtained at the same time. According to this scheme, not only a differential image but also an image with good enough sensitivity can be obtained at the same time just by making computations between images without using any mechanically driven parts.

### BRIEF DESCRIPTION OF DRAWINGS

FIG. 1 illustrates an overall arrangement for an image capture device as a first preferred embodiment of the present invention.

FIG. 2 schematically illustrates how light is incident on the solid-state image sensor of the first preferred embodiment of the present invention.

FIG. 3 illustrates a basic arrangement of pixels in the solid-state image sensor of the first preferred embodiment of the present invention.

FIG. 4 is a front view illustrating the light-transmitting plate of the first preferred embodiment of the present invention.

FIG. 5 is a graph showing how the denominator values were calculated by Equation (14) in the first preferred embodiment of the present invention.

FIG. 6 is a graph showing how the denominator values were calculated by Equation (15) in the first preferred embodiment of the present invention.

FIG. 7 illustrates conceptually an example of two images with parallax according to the present invention.

FIG. 8 illustrates a basic arrangement of pixels in another solid-state image sensor according to the first preferred embodiment of the present invention.

FIG. 9 is a front view illustrating another light-transmitting plate according to the first preferred embodiment of the present invention.

FIG. 10 illustrates a basic color scheme for an image capturing section of a solid-state image sensor according to a second preferred embodiment of the present invention.

FIG. 11 is a front view illustrating the light-transmitting plate of the second preferred embodiment of the present invention.

FIG. 12 illustrates an arrangement for an image capturing system according to Patent Document No. 1.

FIG. 13 illustrates an arrangement for an image capturing system according to Patent Document No. 2.

FIG. 14 illustrates an arrangement for an image capturing system according to Patent Document No. 3.

### DESCRIPTION OF EMBODIMENTS

Hereinafter, preferred embodiments of the present invention will be described with reference to the accompanying drawings. In the following description, any element shown in multiple drawings and having substantially the same function will be identified by the same reference numeral.

### Embodiment 1

FIG. 1 illustrates an arrangement for an image capture device as a first preferred embodiment of the present invention. As shown in FIG. 1, the image capture device includes: a solid-state image sensor 1 that performs photoelectric conversion; a light-transmitting plate 2 with some polarizing areas; a circular optical lens 3 that images incoming light; an infrared cut filter 4; a signal generating and image signal receiving section 5, which not only generates a fundamental signal to drive the solid-state image sensor but also receives a signal from the solid-state image sensor; an image sensor driving section 6 for generating a signal to drive the solid-state image sensor; an image processing section 7, which processes the image signal to generate multi-viewpoint images, a differential image representing the difference between the multi-viewpoint images, and an ordinary image that has no parallax and good enough sensitivity; and an image interface section 8, which outputs image signals representing the multi-viewpoint images, differential image and ordinary image thus generated to an external device.

The light-transmitting plate 2 has polarizing areas in which two polarizers are arranged and a transparent area, which always transmits the incoming light irrespective of its polarization direction. The solid-state image sensor 1 (which will sometimes be simply referred to herein as an “image sensor”) is typically a CCD or CMOS sensor, which may be fabricated by known semiconductor device processing technologies. On the imaging area of the solid-state image sensor 1, arranged two-dimensionally are a number of pixels (i.e., photosensitive cells). Each pixel is typically a photodiode, which makes a photoelectric conversion and outputs a photoelectrically converted signal (that is an electrical signal representing the quantity of the light received). The image processing section 7 includes a memory that stores various kinds of information for use to perform image processing and an image signal generating section for generating an image signal on a pixel-by-pixel basis based on the data that has been retrieved from the memory.

With such an arrangement, the incoming light is transmitted through the light-transmitting plate 2, the optical lens 3 and the infrared cut filter 4, imaged on the imaging area of the solid-state image sensor 1, and then photoelectrically converted by the solid-state image sensor 1. An image signal generated as a result of the photoelectric conversion is sent through the image signal receiving section 5 to the image processing section 7, where the multi-viewpoint images, the differential image and the ordinary image that has no parallax and good enough sensitivity are generated.

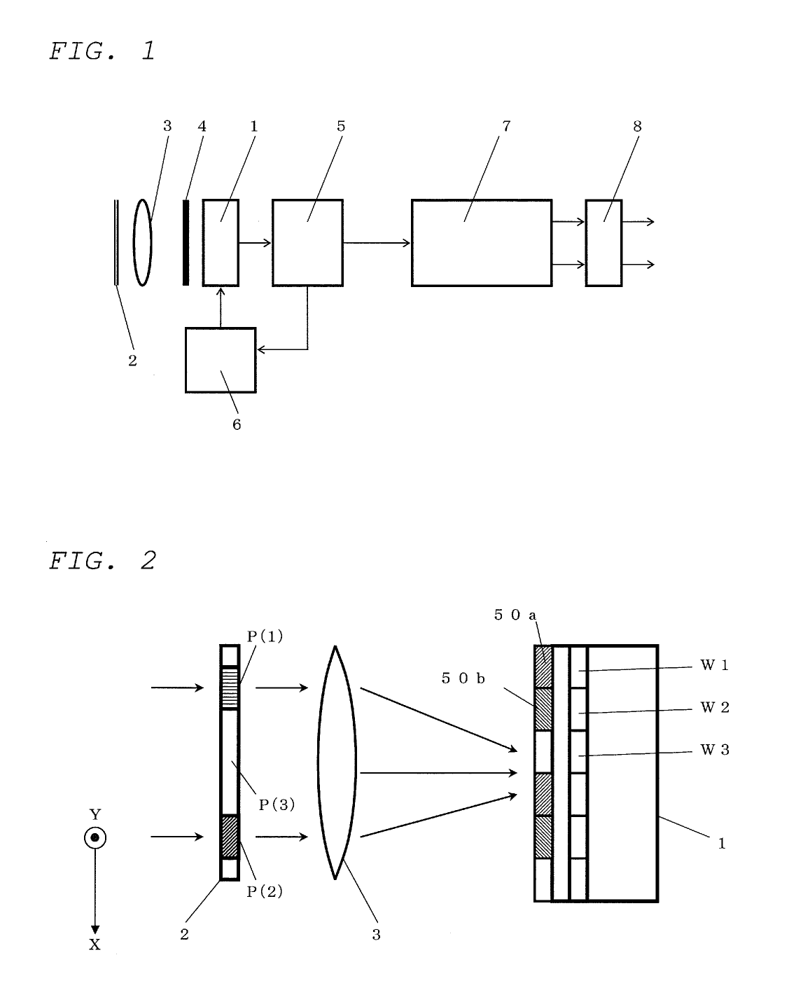

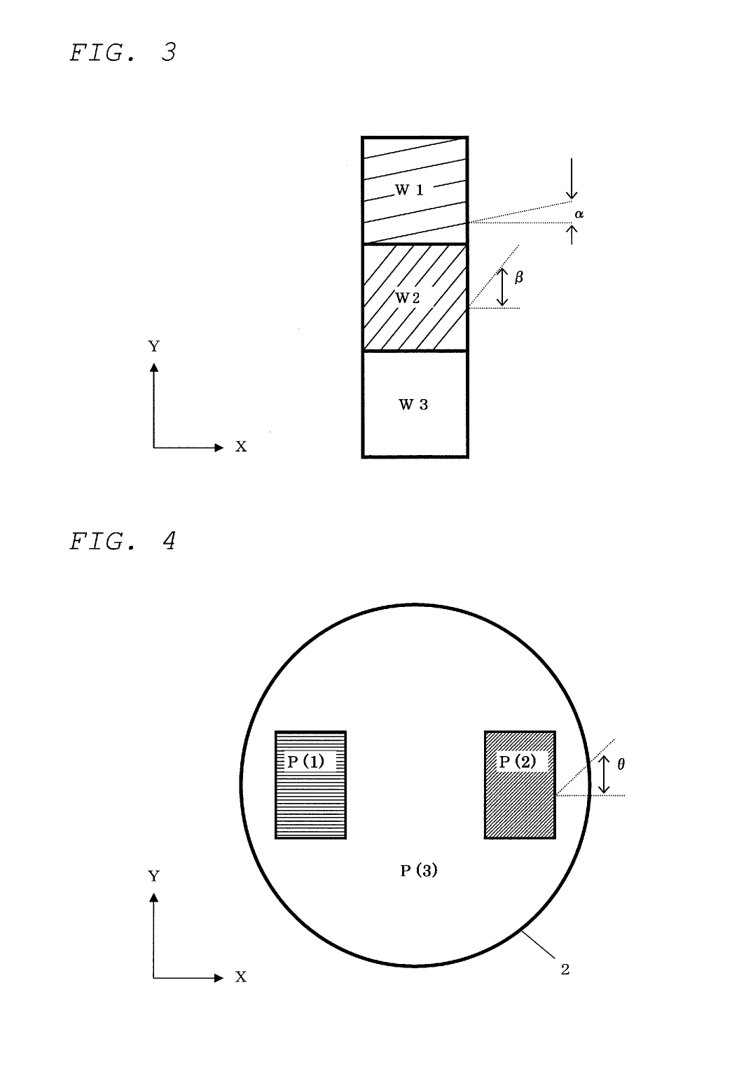

FIG. 2 schematically illustrates how the incoming light is transmitted through the light-transmitting plate 2 and the optical lens 3 and then incident on the imaging area of the solid-state image sensor 1. It should be noted that in FIG. 2, only the light-transmitting plate 2, the optical lens 3 and the solid-state image sensor 1 are illustrated but the other members are not illustrated. Also, as for the solid-state image sensor 1, only a part of its imaging area is illustrated in FIG. 2. As shown in FIG. 2, the light-transmitting plate 2 has two polarizing areas P(1) and P(2) and a transparent area P(3). In this case, these polarizing areas P(1) and P(2) have mutually different transmission axis directions. Meanwhile, multiple pixels that are arranged on the imaging area of the solid-state image sensor 1 form a number of pixel blocks, each of which consists of three pixels (which will be identified herein by W1, W2 and W3, respectively). In this preferred embodiment, polarization filters 50a and 50b are arranged so as to face the pixels W1 and W2, respectively, and also have mutually different transmission axis directions. On the other hand, no polarization filter is provided for the pixel W3.

It should be noted that the arrangement of the respective members shown in FIG. 2 is only an example and the present invention is in no way limited to this specific example. Optionally, as long as the optical lens 3 can produce an image on the imaging area, the optical lens 3 may be arranged more distant from the image sensor 1 than the light-transmitting plate 2 is. Or multiple optical lenses may be arranged as well. Furthermore, the optical lens 3 and the light-transmitting plate 2 do not always have to be independent members but may be two integral parts that form a single optical element. Also, although the pixels W1, W2 and W3 are illustrated in FIG. 2 so as to be arranged in this order in X direction, which is parallel to the line segment that connects together the polarizing areas P(1) and P(2) of the light-transmitting plate 2, this arrangement does not always have to be taken. It should be noted that on the imaging area of the image sensor 1, a number of pixels are also arranged in the direction coming out of the paper on which FIG. 2 is drawn (i.e., in Y direction).

Hereinafter, the arrangement of pixels in the solid-state image sensor 1 and the structure of the light-transmitting plate 2 will be described in further detail. In the following description, the same XY coordinate system as what is shown in FIG. 2 will be used.

FIG. 3 illustrates a pixel block on the imaging area of the image sensor 1. As shown in FIG. 3, a number of pixels are arranged on the imaging area so that their basic unit consists of three pixels in three lines and one column. As described above, each basic unit of pixels (i.e., each pixel block) consists of two pixels W1 and W2, for which two polarization filters 50a and 50b with mutually different polarization directions are provided, and one pixel W3, for which no polarization filters are provided at all. In each pixel block, W1, W2 and W3 are arranged along the Y-axis. As for the transmission axis directions of the polarization filters, the transmission axis of the polarization filter 50a that is located at the row 1, column 1 position defines a tilt angle α (where 0 degrees≦α<90 degrees) with respect to the X direction, and the transmission axis of the polarization filter 50b that is located at the row 2, column 1 position defines a tilt angle β (where 0 degrees≦β<90 degrees and β≠α) with respect to the X direction.

FIG. 4 is a front view of the light-transmitting plate 2 of this preferred embodiment. Just like the optical lens 3, the light-transmitting plate 2 also has a circular shape. In the light-transmitting plate 2, two polarizing areas P(1) and P(2) are defined by two polarizers that have mutually different transmission axis directions and are arranged in the X direction so as to be spaced apart from each other. The rest of the light-transmitting plate 2 other than those polarizing areas is the transparent area P(3). The transmission axis direction of the polarizing area P(1) agrees with the X direction. On the other hand, the transmission axis direction of the polarizing area P(2) defines a tilt angle θ (where 0 degrees<θ≦90 degrees) with respect to the X direction.

The light-transmitting plate 2 has a circular shape in the example illustrated in FIG. 4 but does not always have to have a circular shape. The same can be said about the shape of the polarizing areas P(1) and P(2). That is to say, the polarizing areas P(1) and P(2) do not always have to have a rectangular shape but may have any other shape. Nevertheless, it is still preferred that the polarizing areas P(1) and P(2) have the same area and the same shape.

In this preferred embodiment, the line segment that connects together the respective centers of the pixels W1 and W2 and the line segment that connects together the respective centers of the polarizing areas P(1) and P(2) intersect with each other at right angles as shown in FIGS. 3 and 4.

Using such an arrangement, the respective pixels on the imaging area of the image sensor 1 receive the light that has been transmitted through the polarizing areas P(1) and P(2) and the transparent area P(3) and then condensed by the optical lens 3. Hereinafter, it will be described how those pixels generate photoelectrically converted signals.

First of all, it will be described how the pixel W3 for which no polarization filters are provided generates a photoelectrically converted signal. The pixel W3 just receives the incoming light that has been transmitted through the light-transmitting plate 2, the optical lens 3 and the infrared cut filter 4 and outputs a photoelectrically converted signal representing the quantity of the incoming light received. Suppose the transmittance of the incoming light through the polarizing areas P(1) and P(2) of the light-transmitting plate 2 is identified by T1, and the respective levels of signals to be generated in a situation where the light that has been incident on the polarizing areas P(1) and P(2) and the transparent area P(3) is photoelectrically converted by the image sensor 1 without losing its intensity are identified by Ps(1), Ps(2) and Ps(3) with a subscript s added. In that case, the photoelectrically converted signal S3 generated by the pixel W3 is represented by the following Equation (1):

S3=T1(Ps(1)+Ps(2))+Ps(3) (1)

Next, it will be described how the pixels W1 and W2, for each of which a polarization filter is provided, generate a photoelectrically converted signal. Since the polarization filters 50a and 50b are arranged to face the pixels W1 and W2, respectively, basically the quantity of the light that strikes the pixels W1 and W2 is smaller than that of the light that strikes the pixel W3. Suppose the transmittance of non-polarized light through the polarization filter 50a or 50b is identified by T1 just like the transmittance of the polarizing areas P(1) and P(2), and the transmittance of polarized light, which oscillates in the transmission axis direction of each polarization filter, through that polarization filter is identified by T2. In that case, the levels of the photoelectrically converted signals S1 and S2 generated by the pixels W1 and W2 are represented by the following Equations (2) and (3), respectively:

S1=T1(T2(Ps(1)cos α±Ps(2)cos(α−θ))±Ps(3)) (2)

S2=T1(T2(Ps(1)cos β+Ps(2)cos(β−θ))+Ps(3)) (3)

By eliminating Ps(3) from these Equations (1) to (3), Ps(1) and Ps(2) can be calculated by the following Equations (4) and (5), respectively:

$$\begin{matrix}Ps ( 1 ) = \frac{\begin{matrix}( T 2 cos ( β - θ ) / T 1 - 1 ) {S}_{1} - \\ ( T 2 cos ( α - θ ) / T 1 - 1 ) {S}_{2} + T 2 ( cos ( α - θ ) - cos ( β - θ ) ) {S}_{3}\end{matrix}}{\vert D \vert} & ( 4 ) \\ Ps ( 2 ) = \frac{\begin{matrix}- ( T 2 cos β / T 1 - 1 ) {S}_{1} + \\ ( T 2 cos α / T 1 - 1 ) {S}_{2} - T 2 ( cos α - cos β ) {S}_{3}\end{matrix}}{\vert D \vert} & ( 5 )\end{matrix}$$

In Equations (4) and (5), their denominator |D| is a determinant represented by the following Equation (6):

$$\vert D \vert = \vert \begin{matrix}T 2 cos α - T 1 & T 2 cos ( α - θ ) - T 1 \\ T 2 cos β - T 1 & T 2 cos ( β - θ ) - T 1\end{matrix} \vert \qquad ( 6 )$$

According to these Equations (4) and (5), the image signals Ps(1) and Ps(2) represented by the light that has been transmitted through the polarizing areas P(1) and P(2) and then incident on the imaging area can be calculated based on S1, S2 and S3. Ps(1) and Ps(2) represent two images viewed from mutually different viewpoints. That is why by calculating their difference, information about the depth of the subject can be obtained. According to this preferred embodiment, a signal Ds representing a differential image, which is obtained as the difference between Ps(1) and Ps(2), is given by the following Equation (7):

$$D s = \frac{\begin{matrix}\begin{matrix}T 2 ( cos β + cos ( β - θ ) ) / T 1 - 2 ) {S}_{1} - \\ ( T 2 ( cos α + cos ( α - θ ) ) / T 1 - 2 ) {S}_{2} +\end{matrix} \\ T 2 ( cos ( α - θ ) - cos ( β - θ ) + cos α - cos β ) {S}_{3}\end{matrix}}{\vert D \vert} \qquad ( 7 )$$

In Equation (7), the S3-related term represents a signal associated with the pixel W3 for which no polarization filter is provided, and should not affect the differential image in principle. For that reason, it is preferred that the angles θ, α and β be set so that the S3-related term of Equation (7) becomes as close to zero as possible. If the S3-related term of Equation (7) is sufficiently close to zero, the differential image Ds can be obtained based on only the photoelectrically converted signals S1 and S2 of the pixels W1 and W2. The S3-related term Ds_3 of the differential image Ds can be represented by the following Equation (8):

$$\begin{matrix}Ds\_ 3 = \frac{T 2 ( cos ( α - θ ) - cos ( β - θ ) + cos α - cos β )}{\vert D \vert} {S}_{3} \\ = \frac{- 4 T 2 sin \frac{α - β}{2} sin \frac{α + β - θ}{2} cos \frac{θ}{2}}{\vert D \vert} {S}_{3}\end{matrix} \qquad ( 8 )$$

The numerator of the right side of Equation (8) becomes equal to zero in three imaginable situations, i.e., when α=β, when α+β=θ, and when θ=180 degrees. In the first situation, however, Equations (2) and (3) become equal to each other, and therefore, no information about the differential image can be obtained from the pixels W1 and W2. Likewise, in the third situation, since the polarizing areas P(1) and P(2) have the same polarization direction, information about the light that has been transmitted through one of those two areas becomes no different from information about the light that has been transmitted through the other area. For that reason, according to this preferred embodiment, the transmission axis directions of the polarizing area P(2) and the polarization filters 50a and 50b are determined so that the angle 0 defined by the transmission axis of the polarizing area P(2) with respect to that of the polarizing area P(1) and the angles a and defined by the transmission axes of the polarization filters 50a and 50b satisfy α+β=θ that represents the second situation.

For example, suppose θ=90 degrees, α=22.5 degrees, and β=67.5 degrees. These angles are preferred for the following reason. First of all, if θ is eliminated from Equation (7) based on the relation α+β=θ, Equation (7) can be modified into the following Equation (9):

$$\begin{matrix}Ds = \frac{( T 2 ( cos α + cos β ) / T 1 - 2 ) ( {S}_{1} - {S}_{2} )}{\vert D \vert} \\ = \frac{{S}_{1} - {S}_{2}}{T 1 T 2 ( cos α - cos β )}\end{matrix} \qquad ( 9 )$$

Also, on this condition, the image information represented by the light that has been transmitted through the transparent area P(3) is given by the following Equation (10):

$$Ps ( 3 ) = \frac{- {S}_{1} - {S}_{2} + T 2 ( cos α + cos β ) {S}_{3}}{T 2 ( cos α + cos β ) - 2 T 1} \qquad ( 10 )$$

In this case, since the angle defined by the transmission axis of the area P(1) with respect to the X-direction is zero degrees, the light transmitted through the area P(1) and the light transmitted through the area P(2) can naturally be split most effectively when θ=90 degrees. That is why in this example, α+β=90 degrees is supposed to be satisfied. Meanwhile, as for T1 and T2, T1=½ and T2=1 are supposed to be satisfied.

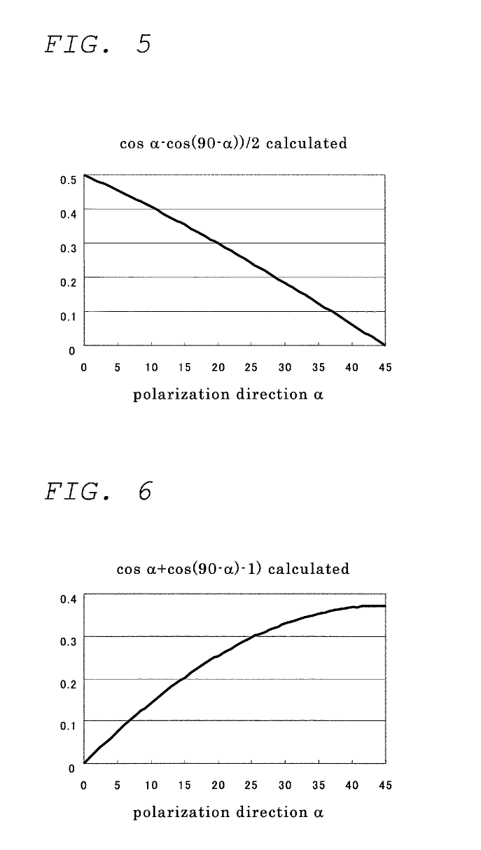

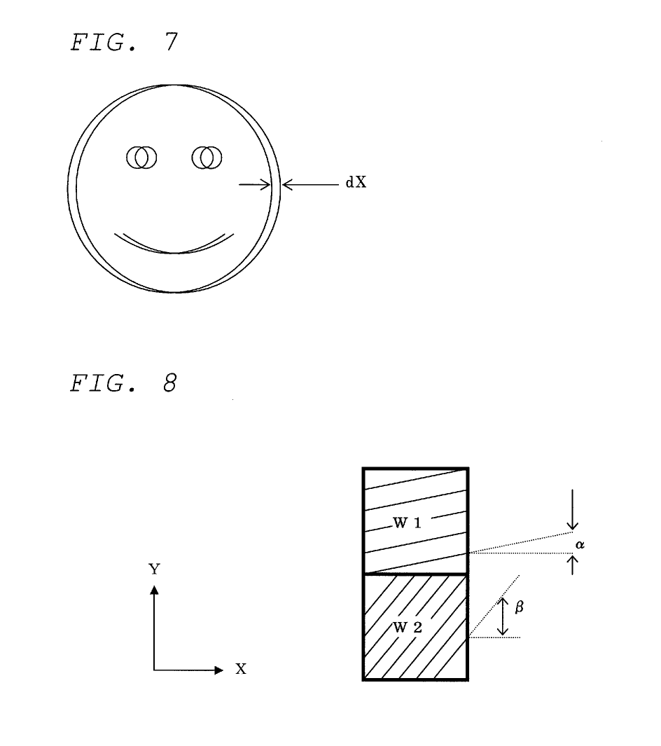

The respective denominator values of Equations (9) and (10) were calculated with a changed within the range of 0 degrees through 45 degrees. The results are shown in FIGS. 5 and 6. As shown in FIG. 5, when α=45 degrees, the denominator of Equation (9) becomes equal to zero. Also, as shown in FIG. 6, when α=0 degrees, the denominator of Equation (10) becomes equal to zero. The closer to zero the denominator values of Equations (9) and (10) are, the more significantly the noise component of the pixel signal is amplified. That is why the α value is supposed to be 22.5 degrees, which is the intermediate value between 0 and 45 degrees, and the β value is supposed to be 67.5 degrees.

By determining the angles θ, α and β as described above, the differential image given by Equation (9) and the image given by Equation (10), which is represented by the light that has come from the transparent area P(3), can be obtained. As for the differential image, the signal is very likely to vary significantly around the subject's profile. That is why by calculating its width (which may be indicated by dX shown in FIG. 7), the depth information can be obtained. Also, the smaller the polarizing areas P(1) and P(2), the higher the level of the image signal represented by the light that has come from the transparent area. For that reason, it is preferred that the polarizing areas P(1) and P(2) be much smaller than the transparent area P(3). Furthermore, as the relative area of the transparent area P(3) increases, the quantity of the light transmitted through the transparent area can be increased, and therefore, an image with increased sensitivity can be obtained.

As described above, in the image capture device of this preferred embodiment, the light-transmitting plate 2 on which the light is incident has two polarizing areas P(1) and P(2) and one transparent area P(3). On the other hand, each basic unit of pixels (i.e., each pixel block) of the image sensor 1 consists of two pixels W1 and W2, for which two polarization filters 50a and 50b with mutually different transmission axis directions are provided, and one pixel W3, for which no polarization filters are provided at all. By setting θ, α and β so that the angle θ defined by the transmission axis of the polarizing area P(2) with respect to that of the polarizing area P(1) and the angles α and β defined by the transmission axes for the pixels W1 and W2 satisfy α+β=θ, the differential image can be obtained efficiently by using only the signals generated by the pixels W1 and W2 that are provided with the polarization filters. In addition, an ordinary two-dimensional image can also be obtained by making computations on the output signals of the pixels W1, W2 and W3. In particular, the smaller the polarizing areas P(1) and P(2), the more likely a two-dimensional image can be obtained with no sensitivity problem raised.

In the example described above, the angle defined by the transmission axis of the polarizing area P(2) with respect to that of the polarizing area P(1) is supposed to be 90 degrees and the angles α and β defined by the transmission axes for the pixels W1 and W2 are supposed to be 22.5 degrees and 67.5 degrees, respectively. However, this is only an example of the present invention and θ, α and β do not have to be these values. Rather the differential image can be obtained irrespective of the α and β values and without using the signal generated by the pixel W3 as long as α+β=θ is satisfied.

It should be noted that even if α +β=θ is not satisfied, the differential image Ds can still be obtained by Equation (7). Nevertheless, the smaller the difference between α+β and θ, the less significant the influence of the S3 term on Equation (7). That is why the difference between the angle θ and α+β is preferably as small as possible. For example, the angles θ, α and β are preferably set so as to satisfy ″θ−(α+β)|≦45 degrees. More preferably, the angles θ, α and β are set so as to satisfy |θ(α+β)|≦20 degrees. It is even more preferred that θ, α and β satisfy |θ−(α+β)|≦10 degrees.

Also, to separate the polarization components of the light rays being transmitted through the two polarizing areas P(1) and P(2) from each other, θ is preferably as close to 90 degrees as possible. θ is preferably set so as to satisfy 60 degrees≦θ≦90 degrees and more preferably set so as to satisfy 80 degrees≦θ≦90 degrees.

In the preferred embodiment described above, a two-dimensional image that would cause no sensitivity problem is supposed to be obtained based on the light that has been transmitted through only the transparent area P(3) by making computations on the pixels. However, the present invention is in no way limited to that specific preferred embodiment. Alternatively, a two-dimensional image may also be obtained by using every one of the light rays that have been transmitted through the areas P(1), P(2) and P(3). In other words, a two-dimensional image may also be generated by synthesizing the signals Ps(1), Ps(2) and Ps(3) together.

Also, in the preferred embodiment described above, the light-transmitting plate 2 is supposed to have two polarizing areas (or polarizers). However, the light-transmitting plate 2 may also have three or more polarizing areas. Furthermore, the transmission axis direction of the polarizing area P(1) does not have to agree with the X direction but may also be any other arbitrary direction.

Moreover, in the example illustrated in FIG. 3, the pixels W1, W2 and W3 are supposed to have a square shape and be arranged adjacent to each other in the Y direction. However, this is just an example of the present invention. Those pixels may have any other shape and the pixels W1, W2 and W3 do not have to be adjacent to each other in the Y direction. Nevertheless, it is still preferred that those pixels be arranged close to each other, to say the least.

In the image capture device of the preferred embodiment described above, light-transmitting plate 2 and the imaging area of the image sensor 1 are arranged parallel to each other as shown in FIG. 2. However, they don't always have to be arranged parallel to each other. Optionally, by interposing an optical element such as a mirror or a prism between them, the light-transmitting plate 2 and the imaging area of the image sensor 1 may also be arranged on two planes that intersect with each other. If such an arrangement is adopted, the angles a and may be determined with respect to the transmission axis direction of the polarizing area P(1) in a situation where the light-transmitting plate 2 and the imaging area of the image sensor 1 are supposed to be parallel to each other with a change of the optical path due to the insertion of that optical element taken into account.

Furthermore, in the preferred embodiment described above, the image capture device is designed to obtain multi-viewpoint images, a differential image and an ordinary image at the same time. However, the present invention is in no way limited to that specific preferred embodiment. Optionally, the image capture device may also be designed to obtain only the multi-viewpoint images and the differential image without getting any ordinary image. If the image capture device is designed for such a purpose, there will be no need to provide the pixel W3 described above and the transparent area P(3) will be replaced with an opaque area that does not transmit light.

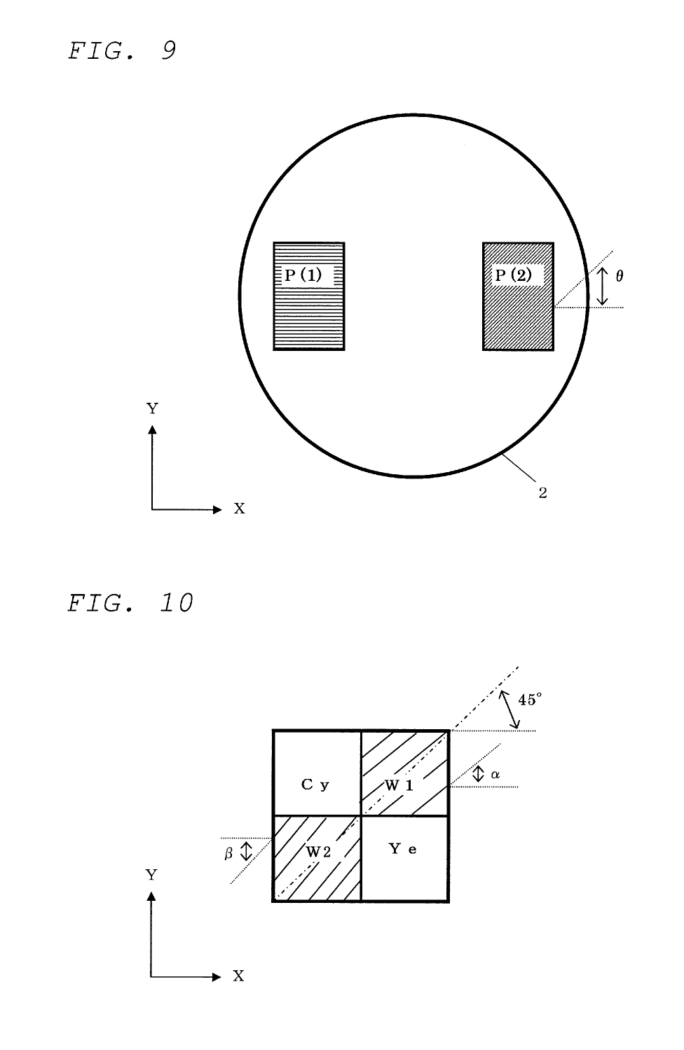

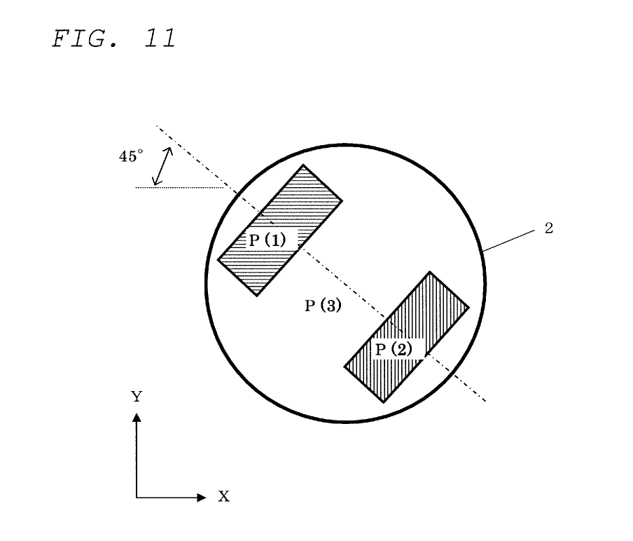

FIGS. 8 and 9 illustrate a basic pixel arrangement and an exemplary structure of a light-transmitting plate 2 for an image capture device that obtains only multi-viewpoint images and a differential image without getting any ordinary image. In that case, on the imaging area of the image sensor 1, arranged are a number of pixel blocks, each of which consists of two pixels W1 and W2. On the other hand, the rest of the light-transmitting plate 2 other than the polarizing areas P(1) and P(2) is an opaque area.

With such an arrangement adopted, the photoelectrically converted signals S1 and S2 that are output from those pixels W1 and W2 are calculated by the following Equations (11) and (12), respectively:

S1=T1T2(Ps(1)cos α+Ps(2)cos(α−θ) (11)

S2=T1T2(Ps(1)cos β+Ps(2)cos(β−θ) (12)

By modifying these Equations (11) and (12), Ps(1) and Ps(2) can be calculated by the following Equations (13) and (14), respectively:

$$\begin{matrix}Ps ( 1 ) = \frac{S 1 cos ( β - θ ) - S 2 cos ( α - θ )}{T 1 T 2 \vert D \vert} & ( 13 ) \\ Ps ( 2 ) = \frac{- S 1 cos β + S 2 cos α}{T 1 T 2 \vert D \vert} & ( 14 )\end{matrix}$$

where |D| is a determinant given by the following Equation (15):

$$\vert D \vert = \vert \begin{matrix}cos α & cos ( α - θ ) \\ cos β & cos ( β - θ )\end{matrix} \vert \qquad ( 15 )$$

Meanwhile, by calculating the difference between Ps(1) and Ps(2), the differential image can be given by the following Equation (16):

$$Ds = \frac{S 1 \{ cos ( β - θ ) + cos β \} - S 2 \{ cos ( α - θ ) + cos α \}}{T 1 T 2 \vert D \vert} \qquad ( 16 )$$

As indicated by Equations (13), (14) and (16), the signals Ps(1), Ps(2) and Ds can be obtained based on the photoelectrically converted signals S1 and S2 provided by the pixels W1 and W2. Such an image capture device can obtain multi-viewpoint images and a differential image without getting any ordinary image.

### Embodiment 2

Hereinafter, a second preferred embodiment of the present invention will be described. The major difference between the first preferred embodiment described above and this second preferred embodiment lies in the pixel arrangement of the solid-state image sensor 1 and the direction that the light-transmitting plate 2 faces. But in the other respects, this preferred embodiment is quite the same as the first preferred embodiment. Thus, the following description of the second preferred embodiment will be focused on only those differences from the first preferred embodiment.

FIG. 10 illustrates a basic pixel arrangement on the imaging area of the solid-state image sensor 1 of this preferred embodiment. In this preferred embodiment, either color elements (color filters) or polarization filters are arranged in two columns and two rows so as to face their associated pixel. The color elements of this preferred embodiment are known color filters, which transmit only color components falling within particular wavelength ranges. In the following description, a color filter that transmits only light with a color component C will be referred to herein as a “C element”, for example.

As for color elements, a cyan element Cy is arranged at the row 1, column 1 position, a yellow element Ye is arranged at the row 2, column 2 position, but no color elements are arranged at the row 1, column 2 position or at the row 2, column 1 position. A polarization filter, of which the polarization direction defines an angle α with respect to the X direction, is arranged as an element at the row 1, column 2 position. And a polarization filter, of which the polarization direction defines an angle β with respect to the X direction, is arranged as an element at the row 2, column 1 position. This pixel arrangement forms a square matrix, and therefore, the line segment that connects together the respective centers of the two polarization filters, which are arranged to face the two pixels W1 and W2, defines a tilt angle of 45 degrees with respect to the X direction.

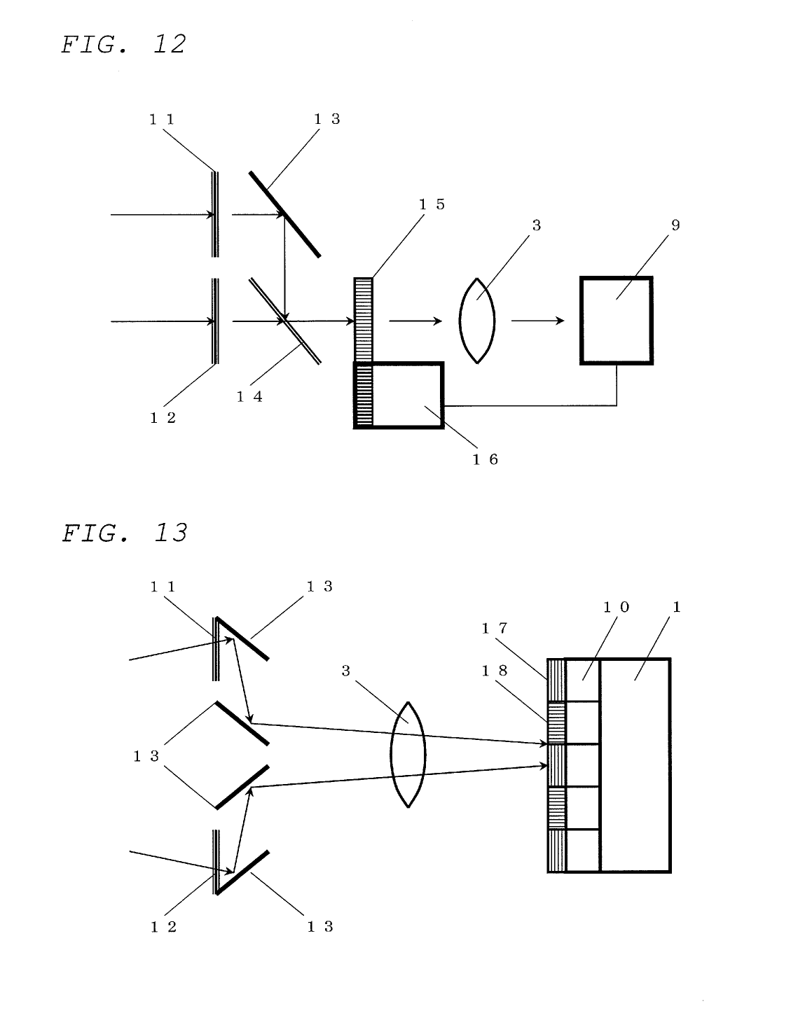

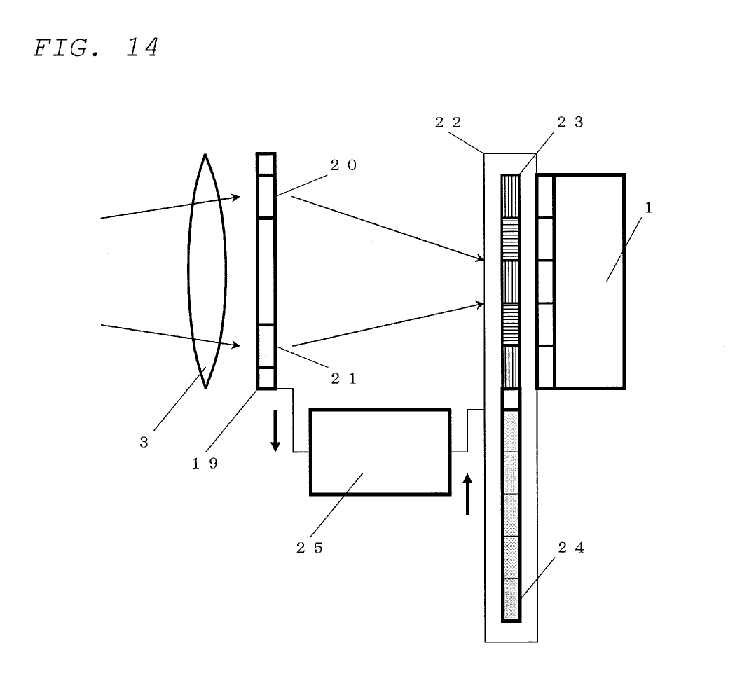

FIG. 11 is a front view of the light-transmitting plate 2 of this preferred embodiment. This light-transmitting plate 2 has a circular shape and the same effective diameter as the optical lens 3. The light-transmitting plate 2 also has a rectangular polarizing area P(1) that polarizes the incoming light in the X direction in the upper left position in FIG. 11, and further has a polarizing area P(2) that polarizes the incoming light in the Y direction in the lower right position in FIG. 11. The polarizing area P(2) has the same size as the polarizing area P(1). The rest of the light-transmitting plate 2 other than P(1) and P(2) is a transparent area P(3) that always transmits the incoming light irrespective of its polarization direction. In this case, if the transmission axis direction of the area P(1) defines an angle of 0 degrees with respect to the X direction, the transmission axis direction of the area P(2) defines an angle of 90 degrees with respect to the X direction. The line that passes the respective centers of these polarizing areas P(1) and P(2) and the line that passes the respective centers of the two polarization filters shown in FIG. 10 cross each other at right angles. Furthermore, as in the image capture device of the first preferred embodiment described above, the transmission axis directions of these polarizing areas P(1) and P(2) and the two polarization filters also satisfy the relation α+β=90 degrees.

The image capture device of this preferred embodiment has the following two major features. First of all, the line that passes the respective centers of the polarizing areas P(1) and P(2) and the line that passes the respective centers of the two polarization filters shown in FIG. 10 cross each other at right angles. The other prime feature is that the image sensor of this preferred embodiment can make a color representation.

Hereinafter, it will be described how to generate a differential image according to this preferred embodiment. The differential image is generated basically in the same way as in the first preferred embodiment described above. If the pixels provided with the polarization filters are identified by W1 and W2 and if the photoelectrically converted signals generated by them are identified by S1 and S2, then the differential signal can be calculated by Equation (9) as already described for the first preferred embodiment. According to this preferred embodiment, the line that passes the respective centers of the polarizing areas P(1) and P(2) defines an angle of rotation of 45 degrees with respect to the X direction and the line segment that connects together the respective centers of the pixels W1 and W2 also defines an angle of 45 degrees with respect to the X direction. That is why no parallax is produced due to the pixel arrangement.

Next, it will be described how to generate a color image. Suppose a signal generated by photoelectrically converting a light ray that has been transmitted through the cyan element of the image sensor is identified by Scy. A signal generated by photoelectrically converting a light ray that has been transmitted through the yellow element thereof is identified by Sye. And the sum of two pixel signals generated by photoelectrically converting light rays that have been transmitted through the two polarization filters is identified by Sw. In that case, a color signal can be obtained by making the following arithmetic. First of all, information Sr about the color red is obtained by calculating (Sw−Scy). Information Sb about the color blue is obtained by calculating (Sw−Sye). And information about the color green is obtained by calculating (Sw−Sr−Sb) using these color signals Sr and Sb. By making these calculations, an RGB color image can be generated. In this example, suppose each of the polarizing areas P(1) and P(2) accounts for one quarter of the overall transmitting area and the transparent area P(3) accounts for a half of the overall transmitting area. The quantity of the incoming light decreases only in the polarizing areas P(1) and P(2) of the light-transmitting plate 2 and approximately 50% of the incoming light is lost in those areas. On the other hand, the quantity of the incoming light does not decrease in the transparent area P(3). That is why it can be seen that a color image is obtained by using 75% of the incoming light. Optionally, if the polarizing areas P(1) and P(2) are further reduced, the sensitivity of the color image can be further increased.

As described above, in the image capture device of this preferred embodiment, the basic color scheme of the image capturing section of the solid-state image sensor forms a 2×2 matrix. A cyan element Cy is arranged at the row 1, column 1 position. A yellow element Ye is arranged at the row 2, column 2 position. A polarization filter, of which the polarization direction defines an angle α with respect to the X direction, is arranged at the row 1, column 2 position. And a polarization filter, of which the polarization direction defines an angle with respect to the X direction, is arranged at the row 2, column 1 position. On the other hand, a rectangular area P(1) that polarizes the incoming light in the X direction is arranged in the upper left 45 degree direction of the light-transmitting plate 2, and another area P(2) that polarizes the incoming light in the Y direction is arranged in the lower right 45 degree direction as shown in FIG. 11. The latter area P(2) has the same size as the former area P(1). Furthermore, if the relation α+β=90 degrees is satisfied in a situation where the transmission axis of the polarizing area P(2) defines an angle of 90 degrees with respect to the transmission axis of the polarizing area P(1), then a differential image can be obtained based on only the signals of pixels provided with the polarization filters. As a result, a high-sensitivity color image can be obtained effectively.

In the preferred embodiment described above, the areas P(1) and P(2) of the light-transmitting plate are supposed to have a rectangular shape. However, this is just an example of the present invention. Likewise, the pixels W1 and W2 and the areas P(1) and P(2) do not have to be arranged at the positions described above, either. Nevertheless, it is still preferred that the direction that points from the pixel W1 toward the pixel W2 and the direction that points from the area P(1) toward the area P(2) intersect with each other at right angles. Also, the color filters of this preferred embodiment do not always have to be cyan and yellow elements. Speaking more generally, two kinds of color filters, one of which transmits a first-color component and the other of which transmits a second-color component, just need to be arranged there. For example, an arrangement for obtaining a red signal and a blue signal directly as pixel signals by using a red element and a blue element as color filters may be adopted.

Furthermore, according to the present invention, pixels do not always have to be arranged to form such a square matrix. And none of those pixels have to have a square shape, either. Rather, the effects of this preferred embodiment can be achieved as long as each pixel block consists of four pixels, two of which face polarization filters with mutually different transmission axis directions and the other two of which face filters in two different colors.

In the preferred embodiment described above, the transmission axis of the polarizing area P(2) is supposed to define an angle θ of 90 degrees with respect to the transmission axis of the polarizing area P(1). However, according to the present invention, θ does not always have to be 90 degrees. Even if θ≠90 degrees, the differential image can still be obtained by Equation (7). Furthermore, the transmission axis direction of the polarizing area P(1) does not have to agree with the X direction but may also be any arbitrary direction as well.

### Embodiment 3

Hereinafter, a third preferred embodiment of the present invention will be described. The image capture device of this third preferred embodiment has the same configuration as its counterpart of the first preferred embodiment described above. In this preferred embodiment, however, the image processing section 7 adds together a number of differential images accumulated, which is one of the major differences from the image capture device of the first preferred embodiment. Thus, the following description of the third preferred embodiment will be focused on only those differences from the image capture device of the first preferred embodiment. According to this preferred embodiment, as indicated by Equation (9) to calculate Ds, each differential image is obtained based on the difference between the signals of the pixels W1 and W2. That is why the differential image Ds has a lower signal level than an ordinary image represented by Ps(3). In view of this consideration, differential images are obtained a number of times and accumulated and added together, thereby raising the signal level of the cumulative differential image.

Specifically, an ordinary two-dimensional image is calculated and retrieved at a predetermined frame rate, while the differential image is also calculated at the same frame rate but is not retrieved but accumulated and added together and then saved in an image memory. The cumulative differential image thus obtained is retrieved once every N frames (where N is an integer that is equal to or greater than two). In this manner, not only the ordinary two-dimensional image but also the differential image, of which the signal level has been increased by the factor of N, can be retrieved. As a result, the depth information obtained from the differential image can also have its accuracy increased N times.

Optionally, instead of obtaining multiple differential images and adding them together, multiple signals of each pixel signal may be read and added together on a pixel-by-pixel basis, and then the image signals Ps(1), Ps(2) and Ds given by Equations (4), (5) and (7) may be obtained.

In this manner, a differential image with a raised signal level can be obtained.

Alternatively, the time intervals at which signals are read may be changed from one pixel to another. For example, in the pixel arrangement shown in FIG. 3, the pixel W3 for which no polarization filter is provided receives more light, and its signal charge generated would get saturated more easily, than the pixel W1 or W2. For that reason, the signal S3 generated by the pixel W3 may be read at a relatively short time interval, while the signals S1 and S2 generated by the pixels W1 and W2 may be read at a relatively long time interval. By changing the signal reading intervals from one pixel to another in this manner, it is possible to prevent the signal charge from getting saturated at a particular pixel.

Although a memory arranged inside of the image processing section 7 is used in the preferred embodiment described above, the memory may be provided outside of the image processing section 7, too. For example, the memory may be arranged inside of the image sensor 1. Furthermore, the configuration of the image capture device of the first preferred embodiment is supposed to be adopted in the preferred embodiment described above. However, the same effect can also be achieved even by adopting the configuration of the image capture device of the second preferred embodiment described above or any other preferred embodiment of the present invention.

In the first through third preferred embodiments of the present invention described above, the image capture device is designed to obtain both multi-viewpoint images and a differential image. However, the image capture device may also be designed to obtain either the multi-viewpoint images or the differential image. For example, the image capture device may obtain only the multi-viewpoint images and the differential image may be obtained by another computer that is either hardwired or connected wirelessly to the image capture device. Still alternatively, the image capture device may obtain only the differential image and another device may obtain the multi-viewpoint images.

Furthermore, in the first through third preferred embodiments of the present invention described above, the image capture device may also obtain a so-called “disparity map”, which is a parallax image representing the magnitude of shift in position between each pair of associated points on the images, based on the multi-viewpoint images. By getting such a disparity map, information indicating the depth of the subject can be obtained.

### INDUSTRIAL APPLICABILITY

The 3D image capture device of the present invention can be used effectively in every camera that uses a solid-state image sensor, and can be used particularly effectively in digital still cameras, digital camcorders and other consumer electronic cameras and in industrial solid-state surveillance cameras, to name just a few.

### REFERENCE SIGNS LIST

1 solid-state image sensor
2 light-transmitting section (light-transmitting plate)
3 optical lens
4 infrared cut filter
5 signal generating and image signal receiving section
6 image sensor driving section
7 image processing section
8 image interface section
9 image capture device
10 pixel
11 0-degree-polarization polarizer
12 90-degree-polarization polarizer
13 reflective mirror
14 half mirror
15 circular polarization filter
16 driver that rotates polarization filter
17, 18 polarization filter
19 light transmitting section
20, 21 polarized light transmitting section
22 light receiving member optical filter tray
23 particular component transmitting filter
24 color filter
25 filter driving section
50a, 50b polarization filter

1. A 3D image capture device comprising:
a light transmitting section with at least two polarizers;
a solid-state image sensor that receives the light that has been transmitted through the light transmitting section; and
an imaging section that produces an image on an imaging area of the solid-state image sensor,
wherein the light transmitting section includes
a first polarizer, and
a second polarizer, of which the transmission axis defines an angle θ (where 0 degrees<θ≦90 degrees) with respect to the transmission axis of the first polarizer, and
wherein the solid-state image sensor includes
a number of pixel blocks, each of which includes first and second pixels,
a first polarization filter, which is arranged to face the first pixel of each said pixel block and of which the transmission axis defines an angle α (where 0 degrees≦α<90 degrees) with respect to the transmission axis of the first polarizer, and
a second polarization filter, which is arranged to face the second pixel of each said pixel block and of which the transmission axis defines an angle β (where 0 degrees≦β<90 degrees and β≠α) with respect to the transmission axis of the first polarizer, and
wherein the first polarization filter is arranged so as to receive the light rays that have been transmitted through the first and second polarizers, and
the second polarization filter is arranged so as to receive the light rays that have been transmitted through the first and second polarizers.

2. The 3D image capture device of claim 1, wherein the light transmitting section has a transparent area that transmits incoming light irrespective of polarization direction of the light,
each said pixel block further has a third pixel, and
the third pixel receives the light rays that have been transmitted through the first and second polarizers and the transparent area, respectively, and outputs a photoelectrically converted signal representing the quantity of the light received.

3. The 3D image capture device of claim 2, wherein |θ−(α+β)|≦20 degrees is satisfied.

4. The 3D image capture device of claim 2, wherein |θ−(α+β)|≦10 degrees is satisfied.

5. The 3D image capture device of claim 2, wherein 80 degrees≦θ≦90 degrees is satisfied.

6. The 3D image capture device of claim 1, wherein a line that passes the respective centers of the first and second pixels and a line that passes the respective centers of the first and second polarizers intersect with each other at right angles.

7. The 3D image capture device of claim 2, wherein each said pixel block further includes a fourth pixel, and
the solid-state image sensor includes
a first color filter, which is arranged so as to face the third pixel of each said pixel block and to transmit a light ray representing a first color component, and
a second color filter, which is arranged so as to face the fourth pixel of each said pixel block and to transmit a light ray representing a second color component.

8. The 3D image capture device of claim 7, wherein in each said pixel block, the first, second, third and fourth pixels are arranged in matrix, in which the first pixel is arranged at a row 1, column 1 position, the second pixel is arranged at a row 2, column 2 position, the third pixel is arranged at a row 1, column 2 position, and the fourth pixel is arranged at a row 2, column 1 position.

9. The 3D image capture device of claim 7, wherein one of the first and second color filters transmits at least a light ray representing a red component, and the other color filter transmits at least a light ray representing a blue component.

10. The 3D image capture device of claim 7, wherein one of the first and second color filters transmits a light ray representing a yellow component, and the other color filter transmits a light ray representing a cyan component.

11. The 3D image capture device of claim 1, further comprising an image processing section that generates an image representing the difference between two images with parallax using photoelectrically converted signals supplied from the first and second pixels.

12. The 3D image capture device of claim 11, wherein the image processing section reads the photoelectrically converted signals from the first and second pixels a number of times, thereby generating the image representing the difference, of which the signal level has been increased, based on those photoelectrically converted signals that have been read.

13. An image generating method for use in a 3D image capture device, the device comprising:
a light transmitting section that has first and second polarizers; and
a solid-state image sensor that receives the light that has been transmitted through the light transmitting section,
the solid-state image sensor including:
first and second pixels;
a first polarization filter that is arranged to face the first pixel and of which the transmission axis defines an angle α (where 0 degrees≦α<90 degrees) with respect to the transmission axis of the first polarizer; and
a second polarization filter that is arranged to face the second pixel and of which the transmission axis defines an angle β (where 0 degrees≦β<90 degrees and β≠α) with respect to the transmission axis of the first polarizer, and
the method comprises the steps of:
getting a first photoelectrically converted signal from the first pixel;
getting a second photoelectrically converted signal from the second pixel; and
generating an image representing the difference between two images with parallax based on the first and second photoelectrically converted signals.
